(19) United States
(12) Patent Application Publication
(10) Pub. No.: US 2003/0111321 A1
(43) Pub. Date: Jun. 19, 2003

(54) Conveyor clamping guide

(76) Inventors: Steven J. Van Oss, Hamilton, MI (US); John A. Campau, Zeeland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/017,960

(22) Filed: Dec. 14, 2001

(51) Int. Cl. B65G 47/26

(52) U.S. Cl. 198/426

(57) ABSTRACT

A clamping guide including clamps, a clamp actuator and alignment guides where the alignment guides are coupled to and actuated with the clamps. In the preferred embodiment, a pair of clamps and alignment guides are positioned on opposite sides of a power conveyor so that a procession of product, such as blocks, passes between the clamps and between the alignment guides. Each alignment guide is coupled to a corresponding clamp with a linkage. The linkage is configured so that as the clamps close against a portion of the procession on the conveyor, the alignment guides engage another portion of the procession upstream from the clamps to align product between the guides. In another preferred embodiment, the linkage couples the alignment guides to the clamps so that when the clamps are partially or fully withdrawn from the procession, the alignment guides are closer to the procession than the clamps, thereby preventing product from contacting and twisting on edges of the clamps.

### BACKGROUND

The present invention relates to conveyors and more particularly to an alignment system for use with conveyors to align conveyed product.

In certain material handling industries, it is desirable to convey a procession of products on a conveyor system, stop flow of the procession and perform some operation on individual units in the procession. For example, in the concrete block manufacturing industry, blocks are typically conveyed in procession on a conveyor to a patterning station, where individual blocks are turned relative to other blocks in the procession. This is usually done to prepare a group of blocks in the procession for staggered stacking in multi-tiered shipping stacks. Typically, one or more blocks, also referred to as “groups,” are separated from the upstream procession of blocks for turning.

A clamp, positioned at the end of a conveyor but upstream from the patterning station, is used to perform this separation. After a group of blocks to be turned passes the clamp, the clamp clamps against the next blocks in the procession. The passed group of blocks continues to the patterning station, where they are turned. After turning, the clamp releases the clamped blocks and the process is repeated.

Frequently on conveyor systems, mis-aligned blocks jam in a clamp because they cannot be squarely clamped. The blocks become twisted or mis-aligned due to collision with other blocks or conveyor vibration. To un-jam the clamp, an operator must manually remove or re-orient the block in the clamp, resulting in production down time. Furthermore, efforts to reorient the blocks in the clamp are potentially dangerous.

### SUMMARY OF THE INVENTION

The aforementioned problems are overcome in the present invention wherein a clamping guide is provided with a clamp and an alignment guide that are coupled to and actuated with each other. The clamp and alignment guide are configured so that as the clamp stops a conveyed procession of product, the alignment guide simultaneously aligns the procession upstream of the clamp.

In the preferred embodiment, a pair of clamps are mounted across from one another on a conveyor that conveys a procession of blocks between the clamps. A drive ram extends and retracts the clamps against individual blocks on the conveyor to stop the upstream procession. A linkage couples each of the clamps to corresponding alignment guides positioned upstream from the clamps. The linkage is configured to actuate each of the guides with each of the clamps so that as the clamps extend to stop the procession, the guides align blocks upstream from the clamps.

In a more preferred embodiment, the linkage couples the guides to the clamps so that as the clamps are retracted by the drive ram and fully withdrawn from the procession, the alignment guides remain closer to the procession than the clamps. Accordingly, the alignment guides protect edges of the clamps from the edges of passing blocks, thereby preventing corners of blocks snagging and twisting on the clamp edges.

The present invention provides a simple and effective clamping guide to stop and simultaneously align a procession of product. The present invention preferably utilizes one drive system to extend and retract clamps and corresponding alignment guides, thereby eliminating the need for additional drive systems to operate each individually. Further, the retarded retraction of the alignment guides relative to the clamps allows the alignment guides to provide a secondary function of preventing clamp edges from snagging and turning passing product.

These and other objects, advantages and features of the present invention will be more readily understood and appreciated by reference to the detailed description of the preferred embodiments and the drawings.

### BRIEF DESCRIPTION OF THE DRAWINGS

FIG. 1 is a perspective view showing the clamping guide of the present invention;

FIG. 2 is a top plan view of the clamping guide;

FIG. 3 is an enlarged top plan view of a linkage of the clamping guide in an extending position;

FIG. 4 is an enlarged top plan view of the linkage in a retracting position; and

FIG. 5 is a perspective view of the linkage.

### DETAILED DESCRIPTION OF THE PREFERRED EMBODIMENTS

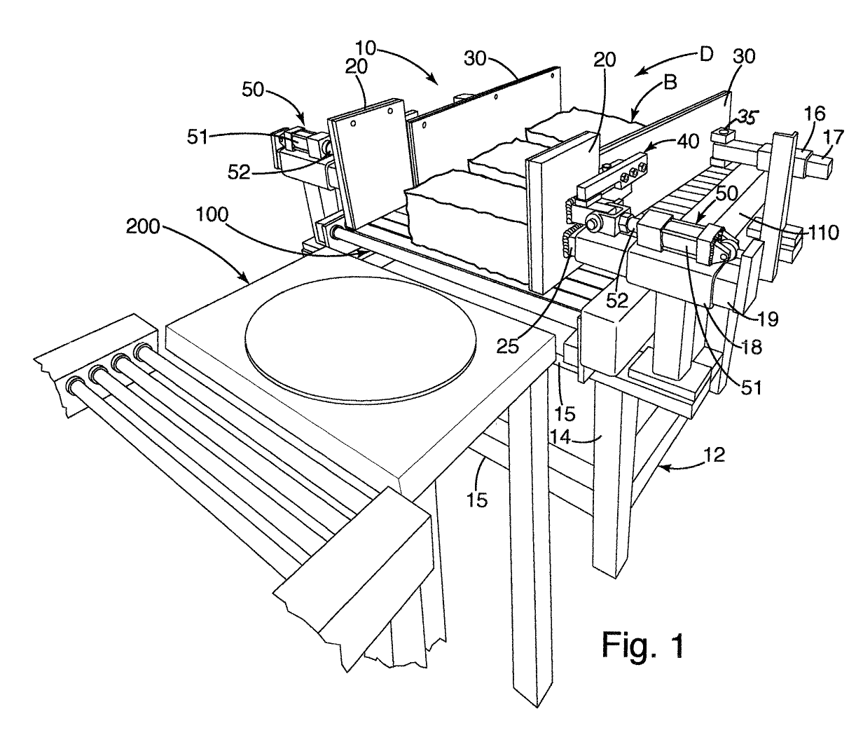

A clamping guide in accordance with a preferred embodiment of the present invention is shown in FIG. 1 and generally designated 10. The clamping guide 10 generally includes a frame 12, clamps 20, alignment guides 30, a linkage 40, which couples the clamps 20 to corresponding alignment guides 30, and actuators 50 for extending and retracting the clamps 20 toward and away from one another. By way of example, FIG. 1 also shows a power roller conveyor 100, which is driven by a conventional roller conveyor drive 110. The power roller conveyor 100 conveys a procession downstream in direction D through the clamping guide 10. By way of further example, the clamping guide 10 is also shown upstream from patterning station 200, which is shown in general detail. As will be appreciated, although a patterning station 200 is illustrated, the clamping guide 10 of the present invention is well suited for use with other product processing stations. In operation, the actuators 50 drive clamps 20 toward blocks in procession B until the clamps 20 clamp against one or more individual blocks. This prevents those clamped blocks from being conveyed or pushed downstream by upstream line pressure caused by blocks accumulating against the clamped blocks. As the clamps 20 are driven, the linkages 40 simultaneously actuate the alignment guides 30 to move toward the procession of blocks B with the corresponding clamps 20. As the guides engage the procession of blocks B, the linkages allow the alignment guides to align blocks between the guides, thereby aligning the procession of blocks B immediately upstream from the clamps. Preferably, the guides 30 align, but do not clamp the blocks.

Accordingly, when individual blocks in the procession B reach the clamping guide 20, they are squarely aligned between the clamps so that they are not crushed by or mis-aligned within the clamps 20. Preferably, when the clamps 20 are withdrawn by the actuator 50, the corresponding alignment guides 30 are also withdrawn. When the clamps 20 are fully withdrawn, the alignment guides are positioned closer to procession B than the clamps 20. In this configuration, the individual blocks in the procession B are unlikely to snag on edges of the clamps because the blocks are deflected from the clamps 20 by the alignment guides 30.

With reference to FIG. 1, the clamps 20, clamping actuators 50 and alignment guides 30 are preferably mounted to frame 12. The frame 12 generally includes base members 14, which are connected to one another by transverse beams 15 located under the conveyor 100 and conveyor drive 110. Alignment frame members 16 are mounted to the transverse beams 15. Likewise, clamp frame members 18 are mounted to the transverse beams 15 near the clamps 20.

The configuration, size and location of the elements of the frame may vary from application to application depending on the desired configuration of the clamps 20 and clamping guides 30. Power roller conveyor 100 and conveyor drive 110 also are mounted to the transverse beams. As will be appreciated, the clamping guides 10 of the present invention may be retrofitted over an existing conveyor system thereby eliminating the need for the conveyor 100 and associated drive 110. Further, the power roller conveyor 100 may be substituted with a belt or other conventional conveyor system as the application requires.

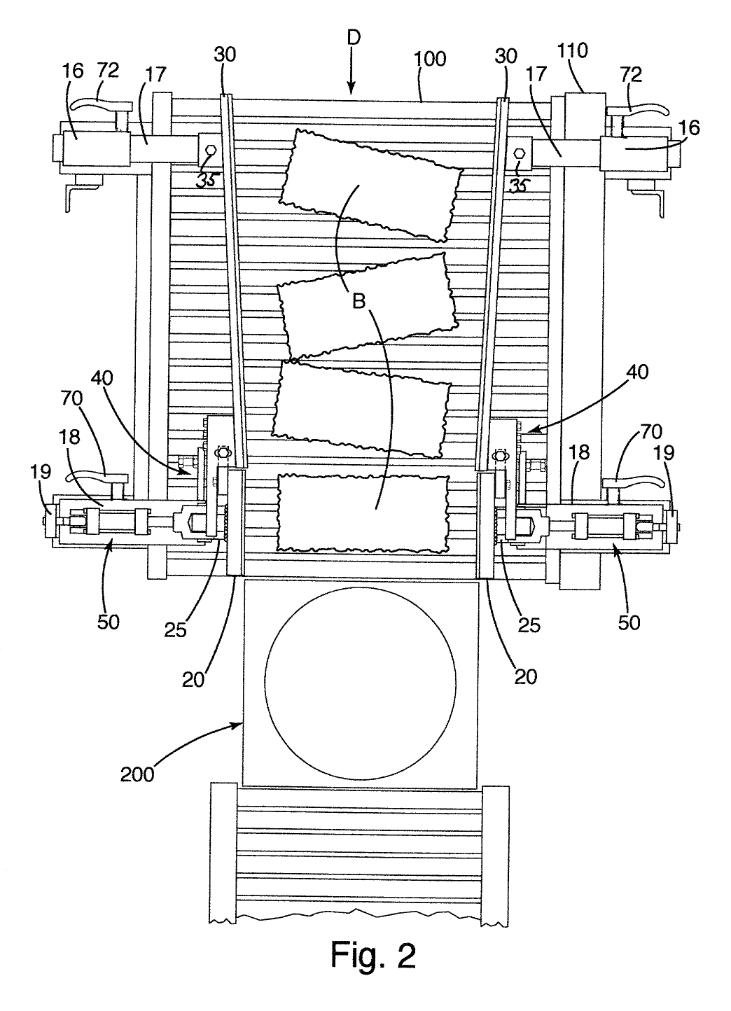

In the preferred embodiment shown in FIGS. 1 and 2, the clamps 20 are movable relative to the frame 12. Preferably, the extender arms 25 are slidably interfit within the clamp slide members 19. Similarly, the alignment guides 30 are moveable with respect to the frame 12. More preferably, the alignment guides 30 are pivotally mounted with mounting pins 35 to the alignment guide slide members 17. Optionally, the interfitting extender arm 25 and clamp slide members may be substituted with any conventional guiding system that allows the clamps 20 to move toward and away from the procession of blocks B, more preferably perpendicular to the procession's line of travel on the power conveyor 100.

The clamp slide members 19 are adjustably interfit within clamp frame members 18. This configuration provides adjustability of the alignment guides to accommodate different sized product. A clamp width adjuster 70 is mounted to clamp frame members 18. The adjuster 70 may be any screw, lasp, hook or other conventional mechanism capable of holding the clamp slide members 19 and clamp frame members 18 in fixed relation to one another, but when de-actuated, allow the clamps 20 to be moved closer to or away from the procession.

The alignment slide members 17 may also be slidably interfit within alignment frame members 16, and adjustable with actuation of alignment guide width adjusters 72, which act on the same premise as the clamp width adjuster 70 explained above.

The clamp actuators 50 are mounted in fixed relation to the frame 12, preferably to the clamp frame members 18. As illustrated, the clamp actuators are hydraulic cylinders 51 with rams 52 extendable and retractable therefrom in a conventional manner. As will be appreciated, the hydraulic cylinders may be replaced with any commercially available actuator system, such as a pneumatic drive, a gear drive, or other drive mechanism, capable of extending and retracting the clamps 20. As the application requires, the actuator 50 may be controlled by a programmable logic control unit (not shown) to control the extension and retraction of the ram 52 and, therefore, movement of the clamps 20.

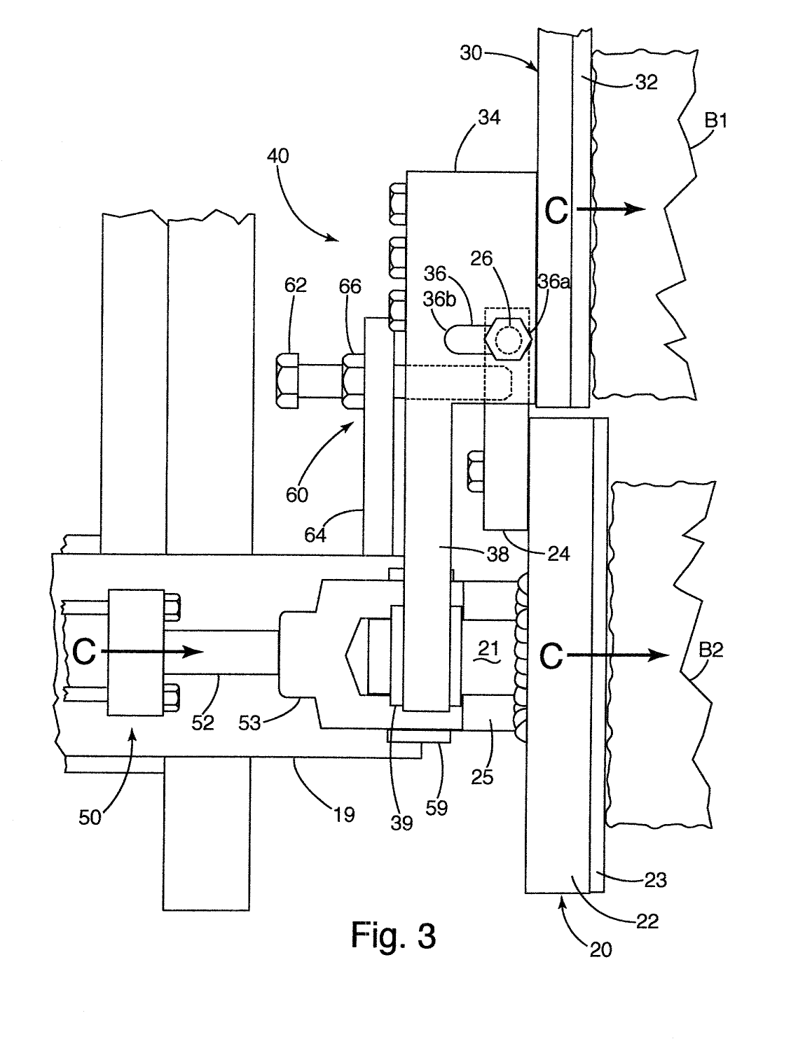

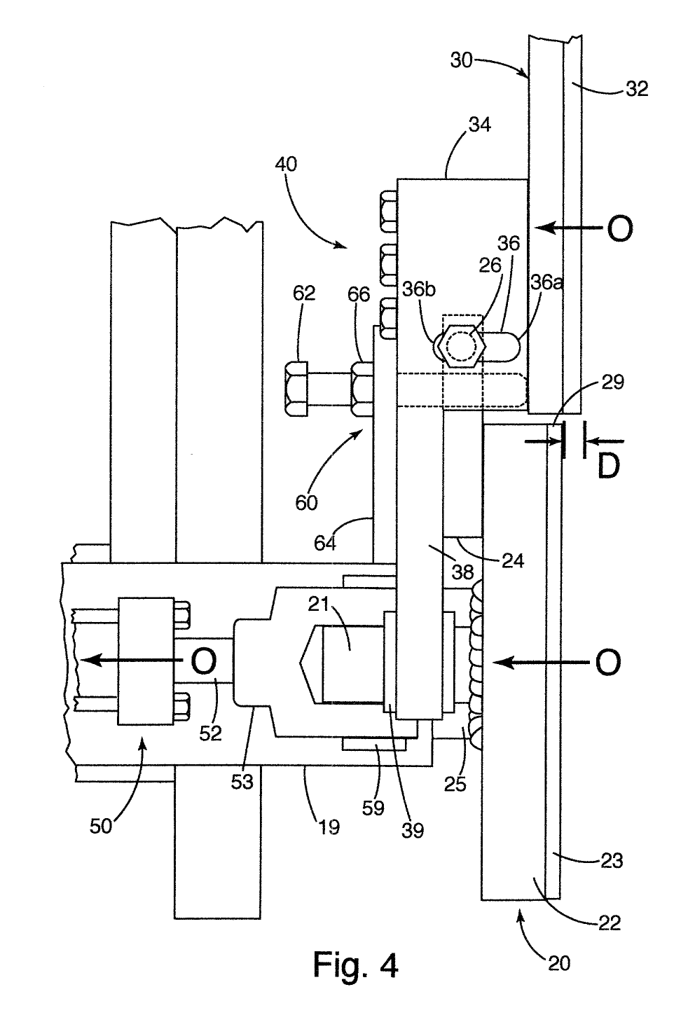

FIGS. 3 and 4 show the actuator 50 and clamps 20 in more detail. The yoke 53 of ram 52 is connected to the clamp 20 with drive arm 21 via yoke pin 59. The clamp 20 is guided in its extension and retraction by interfitment of extender arm 25 in clamp slide member 19. Each of the clamps 20 include a clamping plate 22 to which a wearing plate 23 is secured. The clamping plate 22 is preferably constructed of metal or synthetic material of high strength. The clamp wearing plate 23 preferably is constructed of a high density rubber or plastic material that is resistant to wear. The size and shape of the clamping plate 22 and clamp wearing plate 23 may vary depending on the block or product size. The clamp wearing plate 23 is secured to the clamping plate 22 with bolts, screws, tabs or other fasteners. In some applications, the clamp wearing plate 23 may be eliminated.

As shown in FIGS. 1 and 3, the alignment guides 30 are generally rectangular plate elements constructed of metal or synthetic material of high strength. Preferably, a low-friction plate 32 is secured to the alignment guides 30. This may be done with bolts, screws or other fasteners. The low-friction plate 32 is preferably of a high density polyethylene or other synthetic material. The low-friction plate 32 functions to reduce friction between the alignment guides and passing product, and/or facilitate alignment by allowing the product to easily shift into square between the guides 30. As desired, the low-friction plate 32 may be absent. The alignment guides are generally guided toward one another in a consistent manner with the aid of the linkage 40. Preferably, the guides 30 are pivotally mounted with mounting pin 35 to the alignment slide member 17. As will be appreciated, other mechanisms for ensuring that the alignment guides 30 move toward each other in a consistent manner may be used.

With particular reference to FIGS. 3-5, the alignment guides 20 and clamping plate 22 are coupled together with linkage 40, which generally includes clamp arm 24, guide pin 26, which interfits within journal 36, and guide arm 34. Preferably, the clamping plate 22 is mounted to clamp arm 24, which is preferably mounted on the side of the clamping plate opposite the clamp wearing plate 23. The clamp arm 24 may be secured to the clamping plate 22 by a weld or fasteners such as bolts or screws. Optionally, multiple clamp arms 24 may be secured to the clamping plate. Secured to the clamp arm 24 is guide pin 26 which may be a pin, bolt, shaft or other structure coupled to the clamp arm 24. Although the cross section of guide pin 26 is shown annular, it may be elliptical, square or rectangular, or any other desired shape.

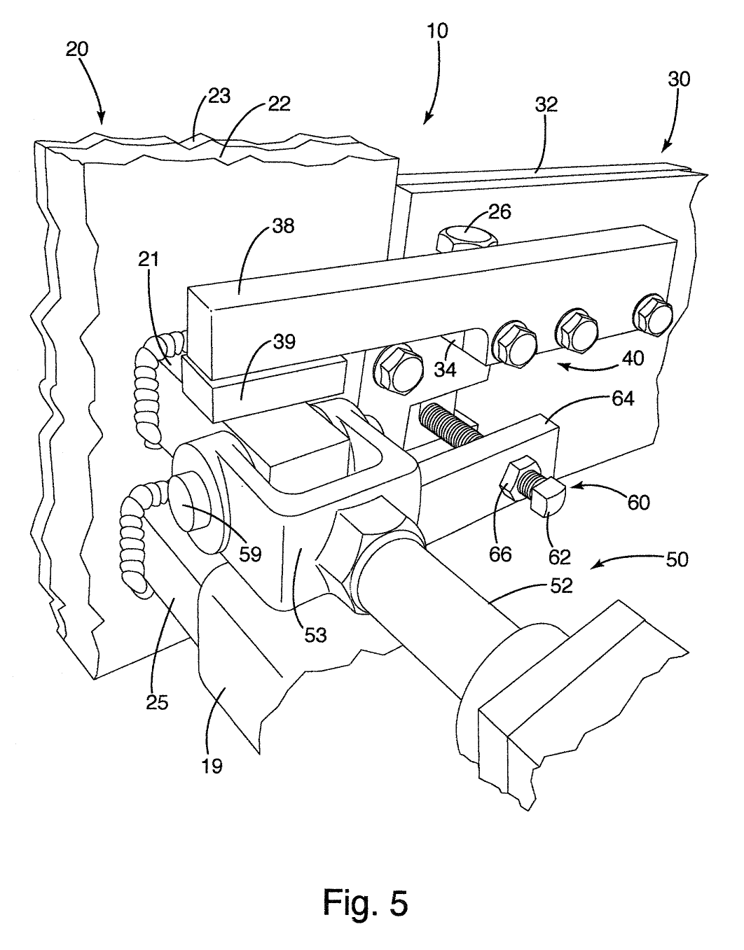

With further reference to FIGS. 3 and 5, the guide arm 34 is secured to or integral with alignment guide 30. Guide arm 34 includes journal 36 including opposing journal ends 36a and 36b. The journal 36 is preferably in the form of a slot, but may be any open channel or other guide mechanism that allows guide pin 26 to move relative to the guide arm 34 in certain positions and engage the guide arm 34 in other positions. Stabilizer arm 38 is secured to or integral with guide arm 34. As will be appreciated, stabilizer arm 38 may be secured directly to the alignment guide 30 as well. The stabilizer arm 38 extends over the drive arm 21. Preferably, friction block 39 is disposed between the stabilizer arm 38 and the drive arm 21. The friction block is constructed of a low friction material to reduce abrasion and wear between the stabilizer arm 38 and the drive arm 21. As will be appreciated, the friction block 39 may be secured to or integral with stabilizer arm 38 or the drive arm 21 as desired.

With reference to FIGS. 3-5, the clamping guide 10 may also include an adjuster 60 to fine-tune the spatial relationship between the alignment guides 30, the clamping guides 20, and their movement relative to procession B. As shown, the adjuster 60 includes bracket 64 to which set screw 62 is movably coupled. The bracket 64 is mounted in a stationary position relative to the alignment guides 30, preferably to the clamping guide frame member 19. The function of the set screw 62 is to adjust the positioning of the guide pin 26 within the guide journal 36 and, therefore, adjust the spatial relationship of the alignment guide 30 with respect to the clamp 20. Locking nut 66 may be tightened against bracket 64 to prevent movement of the set screw 62 relative to the bracket 64.

### Operation

With reference to FIGS. 1, 3 and 4, the operation of the clamping guide 10 will now be explained. As shown in FIG. 1, a procession of blocks B are conveyed by power conveyor 100 downstream in the direction of arrow A toward patterning conveyor 200 or any other block manipulating station as desired. To initiate stopping the procession of blocks B toward the downstream patterning station, the power conveyor 100 is shut down so that it no longer propels the procession of product B, however, downstream. Upstream line pressure from blocks accumulating in the procession B naturally urges the blocks on the power conveyor 100 downstream toward the patterning station 200.

To prevent the procession B from flowing downstream and affecting tasks performed on the patterning station 200, and to align blocks in the procession B, the clamping guides 10 are activated. The clamps 20, and consequently, the alignment guides 30 are driven inward, toward the product procession B, by the clamp actuators 50. Clamps 20 clamp against block B2 (or more blocks if more blocks are between the clamps), to prevent block B2 from moving past the clamps 20. Via the linkage 40, the guides 30 are actuated simultaneously with the clamps 20. The alignment guides push upstream mis-aligned blocks, for example, B1, into alignment so that the procession B generally includes aligned blocks. Preferably, the alignment guides 30 align, but do not clamp against the blocks. Specifically, if only the alignment guides 30 contacted blocks in procession B, the force in contact would not be sufficient to stop the procession B from progressing downstream due to upstream line pressure. Optionally, however, some alignment guides may actually clamp blocks in procession B.

With reference to FIGS. 3 and 4, the interaction of the alignment guides 30, linkage 40 and clamps 20 is shown in more detail. As clamp actuator 50 is actuated, ram 52 drives drive arm 21, and subsequently clamp plate 20, in an extending direction C toward and into contact with block B2. As clamp arm 24 moves with clamping plate 22 the guide pin 26 moves within the journal 36. When the guide pin 26 contacts the journal end 36a, this causes the alignment guide 30 to move inward in direction C toward block B1, which is upstream from block B2.

Preferably, the guide pin 26 and guide arm 34 interact so that in a fully extended position as shown in FIG. 3, the clamp plate 22 clamps against the block B2 whereas the alignment guide 30 and friction-reducing plate 32 align, but do not exert a force that prevents or restricts blocks therebetween from being pushed downstream due to upstream line pressure. More preferably, the effective pressure of the clamping guides against the blocks B1 therebetween is enough to align but not clamp the blocks. Additionally, the set screws 62 may be used to establish the most retracted position of the alignment guides, as shown in FIG. 4. There, the set screw 62 abuts the alignment guide 30 so that it cannot be retracted farther than illustrated.

After the alignment guides 30 have aligned the procession of product therebetween and/or the operations downstream from the clamping guide 10 are completed, the clamp actuator 50 retracts, thereby retracting the clamp plate 22 and alignment guide 30 toward a retracted position as shown in FIG. 4. As the clamp actuator 50 moves the clamp plate 22 in direction 0, the guide pin 26 moves relative to the journal 36 until it engages journal end 36b. At this point, the alignment guide 30 begins to move in direction O with the clamping plate 22. With reference to FIG. 2, the alignment guide pivots about the mounting pin 35 so that the guides are at a slight angle with respect to the product procession D. With reference again to FIGS. 3 and 4, the stabilizer arm 38 slides relative to the drive arm 21 as the clamps 20 and alignment guides extend in direction C toward the procession of blocks or retract in direction O away from the procession. The interaction of the stabilizer arm and drive arm 21 holds the alignment guide 30 off the conveyor 100. Additionally, the stabilizer arm 38 restricts or prevents the alignment guide 30 from excessively tilting or angling from the vertical and horizontal planes.

Preferably, the guide pin 26 engages the journal end 36b so that as the clamps 20 are retracted, the alignment guides 30 lag behind the clamps 20 some distance D. In the fully retracted position, the alignment guides are closer to the product procession a distance D. The set screw 62 may be used to establish this distance D by screwing it into or out from the bracket 64. Accordingly, the alignment guides 30 shield edges of the clamps 20 from product. With this feature, individual blocks moving on the conveyor are less prone to snag on the edges 29 of the clamps 20 and misalign.

After the procession of blocks has been stopped and the blocks upstream from the clamps align between the alignment guides 30, the power conveyor 100 is re-power to move the next block or group of blocks to the patterning station. The process explained above is then repeated again to stop and align the next portion of the product procession.

Although the preferred embodiment of the clamping guide includes pairs of opposing clamps and opposing alignment guides that move toward each other to clamp and align a portion of a procession of product, the clamping guide may alternatively include one clamp and one alignment guide on one side of the power conveyor 100 and a fixed plate or frame member (not shown) on the opposite side of the procession. The operation of this embodiment is identical to that of the preferred embodiment except that a portion of the procession of blocks is clamped and aligned against a fixed member rather than a second set of clamps and alignment guides.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. An apparatus for aligning blocks in a procession that includes leading blocks and trailing blocks comprising:
a frame;
a clamp mounted to said frame;
a clamp actuator coupled to said clamp and operable for movement of said clamp to engage and stop the leading blocks; and
an alignment guide coupled to and moveable with at least one of the frame, the clamp and the clamp actuator so that said alignment guide aligns trailing blocks when said clamp engages and stops the leading blocks.

2. The apparatus of claim 1 comprising a linkage that couples said clamp to said alignment guide.

3. The apparatus of claim 2 wherein said linkage includes a guide pin mounted to said clamp and a guide arm mounted to said alignment guide.

4. The apparatus of claim 3 wherein said guide arm includes a journal in which the guide pin is slidably disposed.

5. The apparatus of claim 4 wherein said journal includes first and second contact ends and wherein said clamp is moveable by said actuator to an extending mode and a retracting mode.

6. The apparatus of claim 5 wherein said guide pin contacts said first contact end in said extending mode whereby the alignment guide moves toward the procession simultaneously with said clamp.

7. The apparatus of claim 5 wherein said guide pin contacts said second contact end in said retracting mode whereby the alignment guide moves away from the procession simultaneously with said clamp.

8. An product alignment system comprising:
a first clamping plate operable between at least an open position and a clamping position wherein said first clamping plate clamps against a product in said clamping position; and
a first alignment guide movable with said first clamping plate, wherein said first alignment guide aligns product when said first clamping plate is in said clamping position.

9. The clamping guide of claim 8 wherein said first clamping plate and said first alignment guide are disposed along a conveyor that conveys a procession of the product.

10. The clamping guide of claim 9 comprising a second clamping plate disposed in opposing relation to the first clamping plate and a second alignment guide disposed in opposing relation to said first alignment guide along the conveyor.

11. The clamping guide of claim 9 comprising a wall member disposed on a side of the conveyor, opposite said first clamping guide and said first alignment guide.

12. The clamping guide of claim 9 wherein said first clamping plate includes edges, and wherein said first alignment guide prevents product from contacting said edges when said clamping plate is in said clamping position.

13. The clamping guide of claim 9 comprising a linkage that couples said first alignment guide to said first clamping plate so that the two are actuated together.

14. The clamping guide of claim 9 comprising a stabilizer arm coupled to said alignment guide to hold said alignment guide a pre-selected distance above the conveyor.

15. A block alignment system comprising:
at least one clamp;
at least one actuator to drive said clamp against and stop a procession of blocks; and
at least one guide plate coupled to and actuatable with said clamp to align at least one block in said procession when said procession is stopped by said clamp.

16. A method of aligning blocks in a procession comprising:
conveying a procession of blocks on a conveyor;
closing a clamp against the procession to prevent the procession from moving;
closing an alignment guide against the procession to align blocks in the procession wherein the clamp and the alignment guide are coupled together with a linkage so that the clamp and alignment guide close against the procession simultaneously.

17. The method of claim 16 comprising retracting the clamp away from the procession wherein the alignment guide retracts away from the procession with the clamp.

18. The method of claim 17 wherein said alignment guide lags behind the clamp in said retracting so that the alignment guide is closer to the procession than the clamp when the clamp reaches a fully retracted position.

19. The method of claim 18 comprising de-powering the conveyor so that it no longer conveys the procession.

20. The method of claim 16 wherein the linkage includes a guide pin further associated with the clamp and a journal further associated with the alignment guide.

21. The method of claim 20 wherein the guide pin moves within the journal during said closing the clamp and said closing the alignment guide.
